(19) United States
(12) Patent Application Publication
(10) Pub. No.: US 2024/0112027 A1
(43) Pub. Date: Apr. 4, 2024

(54) NEURAL NETWORK ARCHITECTURE SEARCH OVER COMPLEX BLOCK ARCHITECTURES

(71) Applicant: Google LLC, Mountain View, CA (US)

(72) Inventors: Yanqi Zhou, Sunnyvale, CA (US); Yanping Huang, Mountain View, CA (US); Yifeng Lu, Palo Alto, CA (US); Andrew M. Dai, San Francisco, CA (US); Siamak Shakeri, New York, NY (US); Zhifeng Chen, Sunnyvale, CA (US); James Laudon, Madison, WI (US); Quoc V. Le, Sunnyvale, CA (US); Da Huang, Santa Clara, CA (US); Nan Du, San Jose, CA (US); David Richard So, Brooklyn, NY (US); Daiyi Peng, Cupertino, CA (US); Yingwei Cui, Los Altos, CA (US); Jeffrey Adgate Dean, Palo Alto, CA (US); Chang Lan, Kirkland, WA (US)

(21) Appl. No.: 18/477,546

(22) Filed: Sep. 28, 2023

Related U.S. Application Data
(60) Provisional application No. 63/377,531, filed on Sep. 28, 2022.

(51) Int. Cl. G06N 3/08

(52) U.S. Cl. CPC G06N 3/08

(57) ABSTRACT

Methods, systems, and apparatus, including computer programs encoded on a computer storage medium, for performing neural architecture search for machine learning models. In one aspect, a method comprises receiving training data for a machine learning, generating a plurality of candidate neural networks for performing the machine learning task, wherein each candidate neural network comprises a plurality of instances of a layer block composed of a plurality of layers, for each candidate neural network, selecting a respective type for each of the plurality of layers from a set of layer types that comprises, training the candidate neural network and evaluating performance scores for the trained candidate neural networks as applied to the machine learning task, and determining a final neural network for performing the machine learning task based at least on the performance scores for the candidate neural networks.

### CROSS-REFERENCE TO RELATED APPLICATION

This application claims priority to U.S. Provisional Application No. 63/377,531, filed on Sep. 28, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that performs neural architecture search for machine learning models.

Particular embodiments of the subject matter described in this specification can be implemented so as to realize one or more of the following advantages.

Transformers are central to recent successes in many machine learning tasks, e.g., natural language processing, computer vision, and so on. The backbone of Transformers is mostly uniform where the same simple building block is used repeatedly. The described techniques, on the other hand, search for an architecture for a more complex block that results in a more efficient architecture. In particular, the complex block can include diverse sets of layers, e.g., sparsely gated feed-forward layers with different gating mechanisms, dense feed-forward layers, attention layers, and various forms of layer normalization and activation functions. The resulting neural network consistently outperforms the state-of-the-art dense and sparse Transformers, in terms of both quality and efficiency. For example, the resulting neural network can demonstrate 2× faster training convergence and 5× faster step time compared to a state-of-the-art Transformer of the same size. Moreover, the resulting neural network can also generalize more effectively to downstream tasks than comparably sized Transformers.

Unlike conventional methods for neural architecture search, which often rely on comparing trained architectures based on a fixed number of computational steps, the described techniques can compare the trained architectures based on the time required to train and based on the time required to process inputs using the trained architectures. This allows the described techniques to optimize the model accuracy of the trained architectures while still taking into account their computational efficiencies. By using a search space that can be constrained to optimizing replicated blocks, the described techniques can obtain optimized neural architectures having a greater complexity than conventional methods for neural architecture search. By including and optimizing complex layer blocks that can process input token sequences in parallel, the described methods allow for a parallelized optimization of certain tasks. The described techniques can therefore perform neural architecture search that can optimize more complex neural architectures while taking account of the computational efficiency of the architectures for training and for inference.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example layer-wise architecture optimization system.

FIG. 2 shows an example evaluation system.

FIG. 3 is a flow diagram of an example process for layer-wise architecture optimization.

FIG. 4 is an illustration of the architecture of an optimized neural network.

FIG. 5 is an illustration of the operation of the process for layer-wise architecture optimization.

FIG. 6 is an illustration of token routing schemes.

Like reference numbers and designations in the various drawings indicate like elements.

### DETAILED DESCRIPTION

These features and other features are described in more detail below.

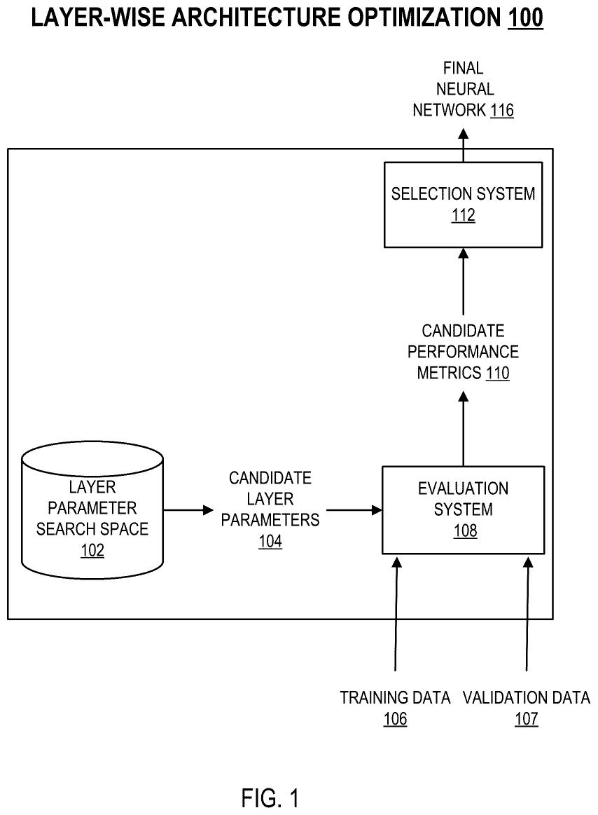

FIG. 1 shows an example layer-wise architecture optimization system 100. The layer-wise architecture optimization system 100 is an example of a system implemented as computer programs on one or more computers in one or more locations in which the systems, components, and techniques described below are implemented.

The system 100 is configured to determine a final neural network 116 that can perform a machine learning task.

The machine learning task can be any machine learning task that requires, as at least part of the machine learning task, processing an input sequence of tokens to generate a network output for the input sequence. For example, the machine learning task can be one that is performed in one pass through the neural network 116 or one that is performed auto-regressively, so that to generate each output in an output sequence for the task, the neural network 116 needs to process an input sequence that includes at least the tokens that have already been generated.

A “token” as used in this specification is a vector of numeric values having a fixed dimensionality. The tokens can be generated from an original input, e.g., by an embedding layer or embedding neural network that is trained jointly with the neural network or that has been pre-trained.

Some examples of machine learning tasks that the final neural network 116 can perform follow.

As one example, the task may be a neural machine translation task. For example, if the input to the final neural network 116 is a sequence of text, e.g., a sequence of words, phrases, characters, or word pieces, in one language, the output generated by the final neural network 116 may be a translation of the sequence of text into another language, i.e., a sequence of text in the other language that is a translation of the input sequence of text. As a particular example, the task may be a multi-lingual machine translation task, where the final neural network 116 is configured to translate between multiple different source language-target language pairs. In this example, the source language text may be augmented with an identifier that indicates the target language into which the final neural network 116 should translate the source language text.

As another example, the task may be an audio processing task. For example, if the input to the final neural network 116 is a sequence representing a spoken utterance, e.g., a spectrogram or a waveform or features of the spectrogram or waveform, the output generated by the final neural network 116 may be a piece of text that is a transcript for the utterance. As another example, if the input to the final neural network 116 is a sequence representing a spoken utterance, the output generated by the final neural network 116 can indicate whether a particular word or phrase (“hotword”) was spoken in the utterance. As another example, if the input to the final neural network 116 is a sequence representing a spoken utterance, the output generated by the final neural network 116 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input and the output is a sequence of intensity values for the pixels of an image.

As another example, the task can be a computer vision task, where the input is an image or a point cloud and the output is a computer vision output for the image or point cloud, e.g., a classification output that includes a respective score for each of a plurality of categories, with each score representing the likelihood that the image or point cloud includes an object belonging to the category. When the input is an image or point cloud, the final neural network 116 can include an embedding subnetwork that generates a respective embedding for each multiple patches of the image or point cloud, and the input to the first block of the neural network can be a sequence that includes the respective embeddings (and, optionally, one or more additional embeddings, e.g., at a predetermined position that will later be used to generate the output). Each patch includes the intensity values of the pixels in a different region of the input image.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

As part of determining the final neural network 116, the system 100 receives and processes training data 106 to train the final neural network 116. The system 100 can also receive and process validation data 107 for the machine learning task.

Generally, both the training data 106 and the validation data 107 include a set of neural network inputs (also referred to as training or validation examples) and, for each network input, a respective target output that should be generated by the final neural network 116 to perform the machine learning task. The training data 106 and the validation data 107 can include different sets of neural network inputs. As an example, the validation data 107 can include a different set of inputs from the training data 106 so that the validation data 107 can be used to effectively measure how well a neural network trained on the training data 106 performs on new inputs.

The system 100 can receive the training data 106 and the validation data 107 in any of a variety of ways. For example, the system 100 can receive example data as an upload from a remote user of the system 100 over a data communication network, e.g., using an application programming interface (API) made available by the system 100. The system 100 can then randomly partition the received example data to into the training data 106 and the validation data 107. As another example, the system 100 can receive an input from a user specifying which example data that is already maintained by the system 100 should be used as the training data 106 and the validation data 107.

As part of determining the final neural network 116, the system 100 generates and trains multiple candidate neural networks to perform the machine learning task and, evaluates the trained candidate neural networks based on certain performance metrics 110.

The system 100 can then determine the final neural network 116 based on the performance metrics 110 for the trained candidate neural networks. The performance metrics 110 characterize aspects of the performance of the trained networks on the machine learning task, e.g. the accuracy, the speed, or the efficiency of the trained networks in performing the machine learning task. Thus, the final neural network 116 is optimized with respect to the performance metrics 110 in performing the machine learning task.

To evaluate a given trained candidate neural network based on the performance metrics 110, the system 100 determines a performance score that characterizes the performance metrics 110. The system 100 can determine the final neural network 116 based on the performance scores for the trained candidate neural networks.

In some implementations, the system 100 can return data specifying the final neural network 116. In some implementations, the system 100 may perform the machine learning task by receiving additional data and processing the received additional data using the final neural network 116.

The candidate neural networks are configured to perform the machine learning task and include multiple processing layers. A given candidate neural network can perform the machine learning task by sequentially processing data generated from input token sequences using the network's included processing layers to generate a final network output. The given candidate network processes an input token sequence by processing the input token sequence using the network's first processing layer to generate a first layer output. For each subsequent processing layer, the given candidate network processes the layer output from the previous layer using the current processing layer to generate a layer output for the current processing layer. The candidate network can return the layer output of the last processing layer as the final network output.

To generate a given candidate neural network, the system 100 determines a layer type and a layer architecture for each of a subset of the processing layers of the given network. The subset of processing layers of a network for which the system 100 determines layer types and layer architectures is referred to as the optimized layers of the network. Within a given candidate neural network, each of the optimized layers can receive and process a token sequence input to the layer to produce a processed token sequence output from the layer. Each optimized layer within a given candidate neural network processes the token sequence input to the layer in accordance with a type assigned to the layer and various architectural and computational parameters assigned to the layer.

The optimized layers of each candidate neural network are organized into layer blocks. Each layer block within a candidate neural network includes one or more of the optimized layers of the network. The candidate neural networks can share a common organization for the optimized layers. For example, the candidate neural networks can share the same number of blocks and a given layer block within the candidate neural networks can include a same number of optimized layers for the given layer block among all of the candidate neural networks.

To generate the candidate neural networks, the system 100 provides sets of candidate layer parameters 104 that specify the type to be assigned to each optimized layer within each candidate neural network. In some implementations, the candidate layer parameters 104 can also include architectural parameters. For example, the candidate layer parameters 104 can include dimensions of certain layer components (e.g. hidden dimensions) as architectural components.

Alternatively, such architectural parameters can be set to pre-determined default values when generating the candidate neural networks.

The candidate layer parameters 104 can specify types and architectures of the optimized layers in any of a variety of ways. For example, the candidate layer parameters 104 can provide a layer-wise specification by including parameters that specify the type and architecture of each optimized layer. As another example, the candidate layer parameters 104 can provide a type-wise specification by including parameters that specify the type of each optimized layer and parameters that specify an architecture for the optimized layers of each type. As another example, the candidates neural networks can include multiple instances of a common layer block and the candidate layer parameters 104 can provide a block-wise specification by including parameters that specify the type and architecture of each optimized layer within the common layer block.

As a particular example, the candidate neural networks can include a stack of instances of the layer block, i.e., that each have the architecture of the layer block but after training can have different parameter values, followed by one or more output layers that process one or more of the tokens in the output of the last layer of the last layer block in the stack to generate the network output. As one example, the output layers can process the last token in the input sequence (after the token has been updated by the last layer of the last layer block), can process the first token in the input sequence (after the token has been updated by the last layer of the last layer block), or can process all of the tokens in the input sequence (after the tokens have been updated by the last layer of the last layer block).

The candidate layer parameters 104 can specify that a given optimized layer within one of the candidate neural networks is a temporal mixture sub-layer, a dense feed-forward sub-layer, or a conditional computational layer.

The temporal mixture sub-layers process input tokens x_{1:n} to produce output tokens y_{1:n} by computing yᵢ=A(xᵢ, x_{1:n} ) in such a manner that captures relationships among the tokens in the input sequence. For example, the temporal mixture sub-layers can apply a self-attention mechanism to the input token sequence. As a more particular example, the temporal mixture sub-layers can apply a causal self-attention mechanism to the input token sequence. The temporal mixture sub-layers can employ multi-headed attention mechanisms, and the candidate layer parameters 104 can optionally include the number of attention heads, h, for each temporal mixture sub-layer as architectural parameters.

The dense feed-forward sub-layers process input tokens x_{1:n} to produce output tokens y_{1:n} by computing yᵢ=f(xᵢ) independently for each token in the input sequence. As an example, the dense feed-forward sub-layers can be position-wise feed forward layers that perform a computation of the form:

f(xᵢ)=max (0, xᵢW₁+b_{1pl )}W₂+b₂

In some implementations, the dense feed-forward sub-layers can perform computations of the form f(xᵢ)=f₂(f₁(xᵢ)), where the dimensionality of the f₁(xᵢ) is different from the dimensionality of the processed token, xᵢ, and is called the hidden dimension of the feed-forward sub-layer. The candidate layer parameters 104 can optionally include the hidden dimensionalities, d_{ffn}, for each feed-forward sub-layer as architectural parameters.

The conditional computational layers operate on each token independently and can select from a set of expert neural networks to process a given token. The conditional computational layers can perform a computation of the form:

$${y}_{i} = {\sum }_{i , j} {G}_{i j} ( {x}_{1 : n} ) {f}_{j} ( {x}_{i} )$$

Where each fⱼ is an expert neural network and Gᵢⱼ is a gating function that determines which expert networks process which input tokens. Gᵢⱼ(x_{1:n}) can be zero for a subset of combinations of input tokens and expert networks, indicating that those combinations of input tokens and expert networks do not need to be computed.

The gating function, Gᵢⱼ, can implement different routing schemes. Examples of routing schemes include token-based gating and expert-based gating.

In top-k token-based gating, Gᵢⱼ is configured such that each token is processed by k expert networks, i.e., each token is routed to k expert networks.

In top-k expert-based gating, Gᵢⱼ is configured such that each expert network processes k tokens, i.e., k tokens are routed to each expert network.

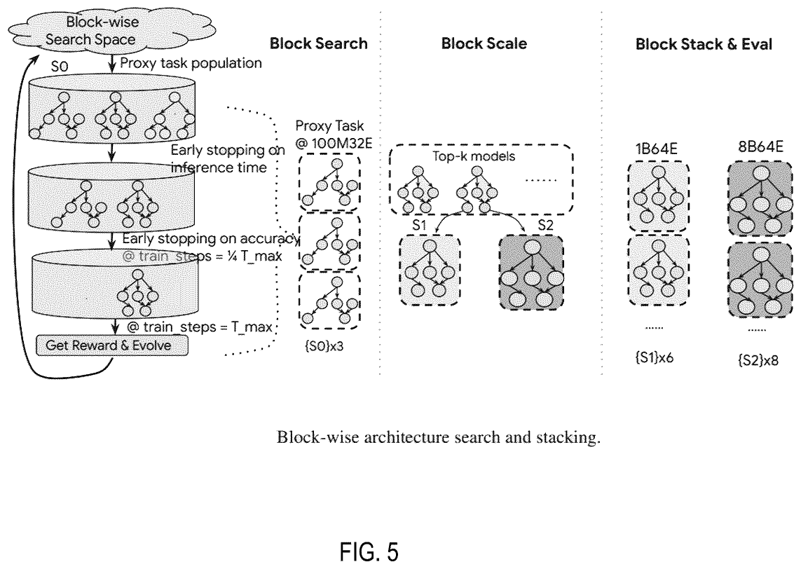

Token-based and expert-based routing are explained in further detail below with reference to FIG. 5.

The maximum number of tokens routed to each expert network, determines the capacity factor of the layer. Additional tokens received by each expert network beyond the capacity factor for the layer are skipped. In particular, the capacity factor of a layer using top-k expert based gating is k.

In some implementations, the expert neural networks can perform computations of the form fⱼ(xᵢ) =f_{j,2}(f_{j,1}(xᵢ)), where the dimensionality of the f_{j,1}(xᵢ) is different from the dimensionality of the processed token, xᵢ, and is called the hidden dimension, of the conditional computational layer.

The candidate layer parameters 104 can include the hidden dimensionalities, dₘₒₑ, the gating function type, g, and the capacity factor, c, for each conditional computational layer as architectural parameters. In some implementations, the candidate layer parameters 104 can include the number of expert networks for each conditional computational layer as an architectural parameter.

The candidate layer parameters 104 can specify the activation function types, a, to be applied to each layer within the candidate neural networks. Examples of these activation function types include the ReLU, GeLU, Gated ReLU, and Gated GeLU functions.

The candidate layer parameters 104 can include the layer dimensions, d, as architectural parameters that specifies the dimensionality of the tokens that each layer of the candidate neural networks process. The system 100 can ensure that each optimized layer within the generated candidate neural networks receives tokens of the specified layer dimension. For example, d can be a single model dimension that specifies the dimensionality for all layers in the candidate neural network and the system 100 can insert a trainable linear layer as the first processing layer of the candidate network that can map tokens from the token dimension of the training data 106 to the specified model dimension. As another example, the system 100 can insert a trainable linear layer between each neighboring pair of processing layers within the candidate neural network that have different layer dimensions such that the trainable linear layer can map tokens from the layer dimension of the first layer of the pair to the layer dimension of the second layer of the pair. As another example, the system 100 can generate the candidate neural network such that the output dimension of each processing layer preceding a given optimized layer matches the specified input dimension of the given optimized layer.

The system 100 includes an evaluation system 108. The evaluation system 108 receives training data 106 and candidate layer parameters 104, generates candidate neural networks based on the received layer parameters 104, trains the candidate networks to perform the machine learning task, and produces candidate performance metrics 110 evaluating each of the trained candidate networks. Training a given candidate neural network to perform the machine learning task can be described as optimizing the computational parameters assigned to each layer within the given network.

The system 100 includes a selection system 112. The selection system 112 can receive the candidate performance metrics 110, determine corresponding performance scores, and can return the final neural network 116 based on the performance scores of the candidate networks.

The system 100 can operate in an iterative manner, generating and testing separate batches of candidate neural networks across multiple iterations and determining a final neural network 116 corresponding to a trained candidate neural network based on the performance scores of the trained candidate neural networks from all of the tested batches. In implementations where the system 100 operates in an iterative manner, the selection system 112 can, at each iteration, store a representation of a trained candidate neural network that optimizes the performance metrics 110 among all previously tested batches.

In implementations where the system 100 operates iteratively, the system 100 can select the iteration at which the final neural network 116 is determined based on any suitable procedure. For example, the system 100 can determine the final neural network 116 after a pre-determined number of iterations. As another example, the system 100 can return a final neural network 116 when a trained candidate neural network attains a performance score satisfying a pre-determined threshold. As another example, the system 100 can iterate repeatedly until a user prompts the system to determine the final neural network 116.

By determining the final neural network 116 that optimizes the performance metrics 110 over the candidate layer parameters 104 processed during the operation of system 100, the system 100 optimizes the architecture of the final neural network 116. In particular, the system 100 optimizes the layer type composition of the final neural network 116. In implementations where the candidate layer parameters 104 include additional architectural parameters, the system 100 optimizes these architectural parameters within the final neural network 116.

The system 100 can store or represent a layer parameter search space 102. As part of determining the final neural network 116, the system 100 can search the layer parameter search space 102. To search the layer parameter search space 102, the system 100 can select layer parameters 104 from the search space to generate candidate neural networks. An example layer parameter search space 102 is provided below in Table 1.

TABLE 1

| SEARCH ITEM | SEARCH SPACE |
|---|---|
| Layer Type | Temporal Mixture, Dense Feed-Forward, |
| | Conditional Computational |
| Model Dimension, d | 512, 768, 1024 |
| MoE Hidden Dimension, dₘₒₑ | 1536, 2048, 3072, 4096 |
| FNN Hidden Dimension, d_{ffn} | 1536, 2048, 3072, 4096 |
| Attention Heads, h | 12, 16, 20 |
| Gating Function, g | Token-Based, Expert-Based |
| Capacity Factor, c | 1, 2, 3, 4 |
| Activation Function, a | Gated ReLU, ReLU, GeLU, Gated GeLU |

In some implementations, the system 100 performs an evolutionary search of the layer parameter search space 102. To perform an evolutionary search over the layer parameter search space 102, the system 100 generally assumes a default fitness for each parameter combination within the layer parameter search space 102. During an evolutionary search, the system 100 selects layer parameters 104 based on representations of the fitnesses of the parameter combinations within the layer parameter search space 102. As the search progresses, the system 100 can determine fitnesses for the tested candidate neural networks and can update the representations of the fitnesses of the parameter combinations within the layer parameter search space 102. In an evolutionary search, the updates to the fitness representations are such that the system 100 generates and tests candidate neural networks with increasing average determined fitness as the search progresses. In some implementations, the updates to the fitness representations can be determined based on the performance scores determined for the tested candidate neural networks such that the system 100 generates and tests candidate neural networks with increasing average performance scores as the search progresses. For example, the system 100 can determine greater fitnesses for candidate neural networks having better performance scores. As a further example, the system 100 can determine the fitnesses for candidate neural networks based on the performance scores subject to one or more constraints on the performance scores, e.g., by determining a minimal fitness for candidate neural networks having performance scores that fall violating the one or more constrains.

During an evolutionary search, the system 100 can store a number of parameter combinations within the layer parameter search space 102, referred to as a population of parameter combinations. The system 100 can implicitly represent the fitness of a given parameter combination within the population based on the number of copies of the given parameter combination within the population. The system 100 can update the fitness representations of the population by adding and removing parameter combinations within the population. For example, the system 100 can, on average, remove parameter combinations for candidate neural networks that the system 100 determines have low fitness. As another example, the system 100 can add copies of parameter combinations for candidate neural networks that the system 100 determines have high fitness. As another example, the system 100 can add modifications of parameter combinations for candidate neural networks that the system 100 determines have high fitness, e.g., the system 100 can add parameter combinations that mix together the parameters of multiple high-fitness parameter combinations.

As one example of the evolutionary architecture search algorithm, more details about a regularized evolution architecture search algorithm can be found in U.S. Publication No. 20200320399 A1, entitled REGULARIZED NEURAL NETWORK ARCHITECTURE SEARCH, which was filed on Jun. 19, 2020 and published on Oct. 8, 2020, which is herein incorporated by reference. As another example of the evolutionary architecture search algorithm, more details about an evolution algorithm with progressive dynamic hurdles can be found in U.S. Pat. No. 10,997,503 B2, entitled COMPUTATIONALLY EFFICIENT NEURAL NETWORK ARCHITECTURE SEARCH, which was filed on Jun. 20, 2019 and issued on May 4, 2021, which is herein incorporated by reference.

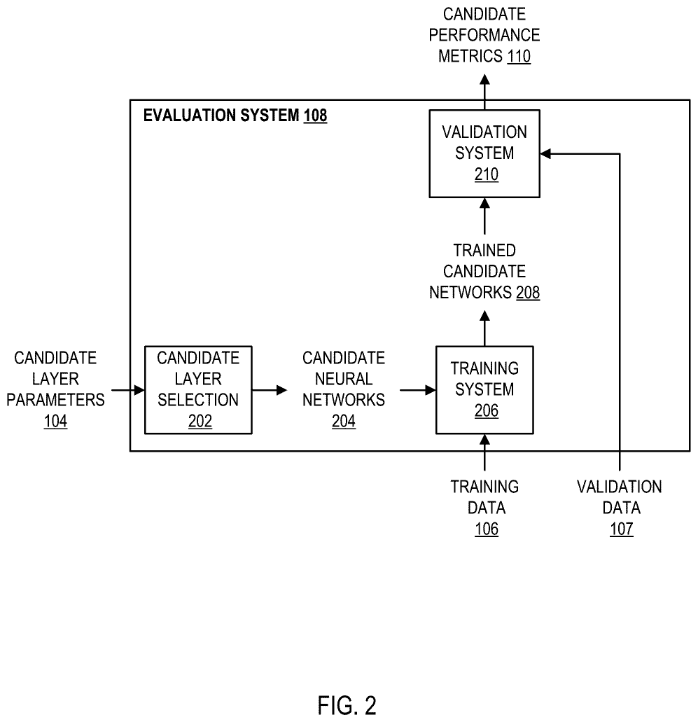

FIG. 2 shows an example evaluation system 108. The evaluation system 108 is an example of a system implemented as computer programs on one or more computers in one or more locations in which the systems, components, and techniques described below are implemented.

The system 108 can receive candidate layer parameters 104, generate corresponding candidate neural networks 204, and train the candidate neural networks 204 on the training data 106 to produce corresponding candidate training metrics 110. The system 108 includes a candidate layer selection system 202 that can appropriately construct candidate neural networks 204 based on the specifications provided by the candidate layer parameters 104.

The system 108 includes a training system 206 that can train candidate neural networks 204 using the training data 106. The training system 206 can train the candidate neural networks 204 using any objective function appropriate for the machine learning task. For example, if the machine learning task is a regression task, an appropriate objective function can be L2 loss. As another example, if the machine learning task is a classification task, an appropriate objective function can be cross-entropy loss.

The training system 206 can train the candidate neural networks 204 on a first set of one or more hardware devices to produce corresponding trained candidate networks 208. For example, the training system 206 can include the first set of hardware devices and train each candidate neural network 204 using the training data 106 on the first set of hardware devices. As another example, the training system 206 can transmit data specifying the candidate neural networks 206 and the training data 106 to the first set of hardware devices and receive data specifying the trained candidate neural networks 208 from the first set of hardware devices.

The first set of hardware devices can include any of a variety of types of hardware devices. For example, the first set of hardware devices can include a set of hardware accelerators, e.g., GPUs or TPUs.

In some implementations, the system 100 can train the candidate neural networks 204 for a pre-determined amount of wall clock time on the first set of hardware devices. In other words, the system 100 trains each candidate network for the same amount of wall clock time, even if the system 100 performs a different number of training steps for different candidate networks during the same amount of wall clock time. Here, wall clock time refers to a length of time measured externally from the first set of hardware devices, e.g. by a user. By training for the candidate networks the same amount of wall clock time, the system 100 can determine final neural networks 116 that have faster training convergence, i.e., attain better performance metrics 110 for the same elapsed training time.

In some of these implementations, the system can use early stopping during the training, i.e., can stop training a candidate architecture after a certain amount of time or a certain number of training steps if the candidate architecture violates an inference time (“step time”) constraint or a performance measure constraint when the certain amount of time or certain number of training steps have elapsed.

The evaluation system 108 includes a validation system 210 that can test the candidate neural networks 204 to generate the candidate performance metrics 110.

The validation system 210 can evaluate and include any appropriate model accuracies in the performance metrics 110. For example, the validation system 210 can include, for each candidate neural network, the average value of the training objective function obtained by the candidate neural network on the training data 106 as a training accuracy within the performance metrics 110. As another example, if the validation data 107 is different from the training data 106, the validation system 210 can include, for each candidate neural network, the average value of the training objective function obtained by the candidate neural network on the validation data 107 as a validation accuracy within the performance metrics 110. As another example, if the validation data 107 is the training data 106, the validation system 210 can include, for each candidate neural network, the average value of an objective function, different from the training objective function, obtained by the candidate neural network on the validation data 107 as a validation accuracy within the performance metrics 110.

In some implementations, the validation system 210 can determine a step time for each of the candidate neural networks 204, and the system 100 can determine the final neural network 116 based on optimizing the performance metrics 110 subject to satisfying pre-determined criteria specifying satisfactory step times.

As an example, these step times can be a measured or estimated times required for the candidate neural networks to process input token sequences when deployed on a second set of hardware devices, such as a target user device. In some implementations, the system 100 can use a step time for a baseline neural network as a baseline step time and can use step times improving upon the baseline step time by at least a pre-determined threshold improvement amount to determine satisfactory step times. As an example, the threshold step time improvement amount can be zero, indicating that any improvement in step time compared to the baseline neural network is considered satisfactory for the final neural network 116.

The second set of hardware devices can include any of a variety of hardware devices. For example, the second set of hardware devices can include the same set of hardware accelerators as the first set of hardware devices. As another example, the second set of hardware devices can include a different set of hardware accelerators. As another example, the second set of hardware devices can include edge devices, e.g., mobile devices, user computers, tablets, and so on.

By thresholding the step times of the candidate neural networks, the system 100 can find a final neural network 116 that performs the machine learning task more efficiently than the baseline neural network. For example, a user may have already trained a given neural network to perform the machine learning task and can provide the given neural network for the system 100 to use as the baseline neural network. By determining a final neural network 116 that reduces the step time compared to the baseline neural network, the system 100 provides the user a neural network that performs the machine learning task more efficiently than the user's given network.

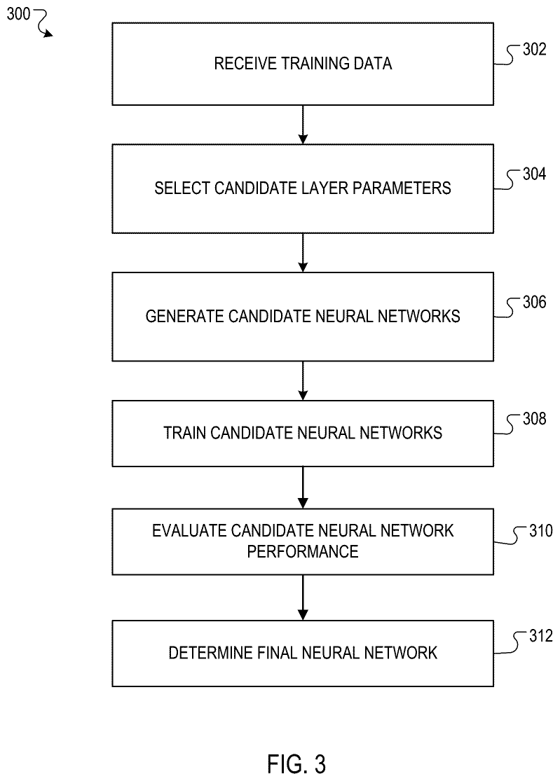

FIG. 3 is a flow diagram of an example process for layer-wise architecture optimization. For convenience, the process 300 will be described as being performed by a system of one or more computers located in one or more locations. For example, a layer-wise architecture optimization system, e.g., the layer-wise architecture optimization system 100 of FIG. 1, appropriately programmed in accordance with this specification, can perform the process 100.

The system receives training data for a machine learning task that requires processing an input sequence of tokens to generate a network output (302). The training data can be a set of example input sequences and a set of example target network outputs.

The system selects candidate layer parameters specifying candidate neural networks that can be trained to perform the machine learning task (304). The candidate layer parameters specify the types of optimized layers, as organized into layer blocks, within the candidate neural networks. The types of optimized layers include a temporal mixture sub-layer, a dense feed-forward sub-layer, and a conditional computational layer. The candidate layer parameters can specify the architectural parameters of the optimized layers, such as hidden dimensions of the optimized layers and the dimension of the tokens processed by the optimized layers. The candidate layer parameters can specify the types and architectures of each optimized layer individually. The candidate layer parameters can also specify the types and architectures of the optimized layer within a common layer block, with the candidate neural networks being formed by multiple instances of the common layer block.

The system generates candidate neural networks based on the selected candidate layer parameters (306).

The system trains the candidate neural networks using at least a portion of the received training data (308).

The system evaluates the performance of the trained candidate neural networks by determining a performance score for the candidate neural networks (310). For example, the performance score can characterize an accuracy of the trained candidate neural networks on the received training data.

As described above, in some implementations, the system can perform steps 304-310 as part of an evolutionary search through the search space. For example, the evolutionary search can be an evolutionary search that is guided by the performance scores for the candidate neural network subject to one or more constraints. During the evolutionary search, the system can repeatedly sample parent architectures from a population of candidate architectures, e.g., using the performance scores and subject to one or more constraints, e.g., subject to a constraint on the step time or on training efficiency, mutate each sampled parent to generate a child architecture, e.g., by applying one or more evolutionary search mutations to the sampled parent, and then train and evaluate the child architecture as described above before adding the child to the population.

The system determines and returns a final neural network from the trained candidate neural networks based at least on the performance scores of the candidate neural networks (312). For example, the system can return the final neural network maximizing accuracy on the received training data subject to providing an improved step time, i.e. the time required to process an input sequence and produce a network output, compared to a given baseline neural network.

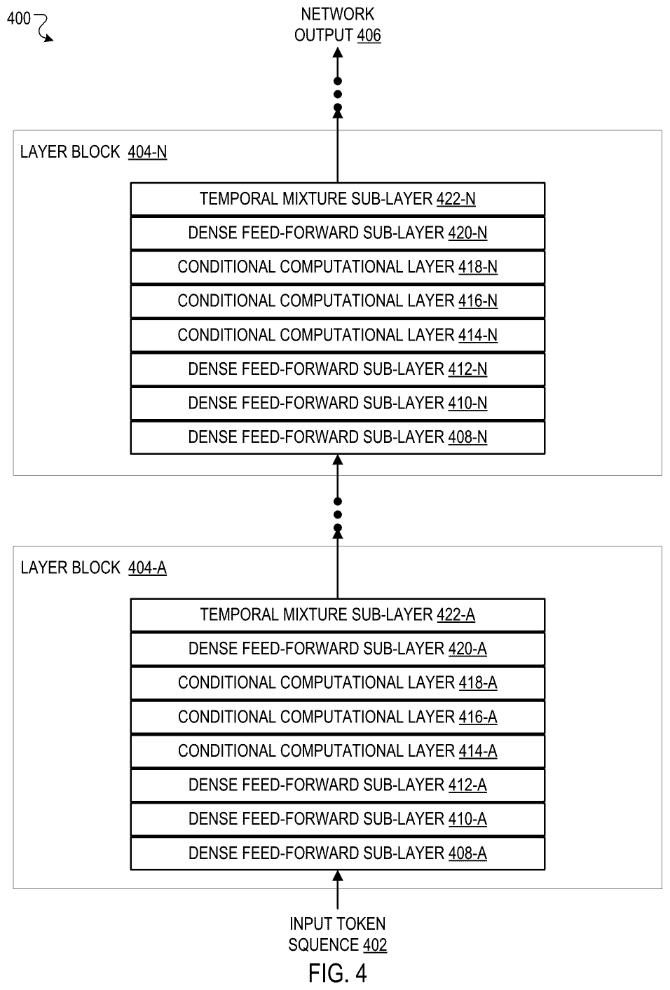

FIG. 4 illustrates an example architecture of a final neural network 400 that can be determined by the process 300.

The final neural network 400 can process an input token sequence 402 to generate a network output 406. The final neural network 400 includes multiple optimized layers. The optimized layers are organized into multiple instances 404-A through 404-N of a common layer block. The common layer block includes four feed-forward sub-layers, three conditional computational layers, and one temporal mixture sub-layer. Layer block 404-A includes the feed-forward sub-layer instances 408-A, 410-A, and 412-A, the conditional computational layer instances 414-A, 416-A, and 418-A, the feed-forward sub-layer instance 420-A, and the temporal mixture sub-layer instance 422-A. Layer block 404-N includes the feed-forward sub-layer instances 408-N, 410-N, and 412-N, the conditional computational layer instances 414-N, 416-N, and 418-N, the feed-forward sub-layer instance 420-N, and the temporal mixture sub-layer instance 422-N.

The candidate layer parameters can specify the architectural parameters for each of the optimized layers within the common layer block. The optimized layer instances within the layer block instances 404-A through 404-N can share the architectural parameters of the corresponding optimized layers of the common layer block.

The final neural network 400 can be the candidate neural network attaining the best performance score among the candidate neural networks evaluated during the process 300.

FIG. 5 illustrates an example operation of the neural architecture search process 300 optimizing a network like the final neural network 400. For example, the process 300 can optimize the architecture of a common layer block by evaluating the performance of neural networks composed of a certain number of instances of the common layer block (i.e. the Block Search phase and the Block Scale phases illustrated by FIG. 5). The process 300 can return a final neural network, e.g., the network 400, composed of a final number of instances of the common layer block (i.e. the Block Stack and Eval phase illustrated by FIG. 5).

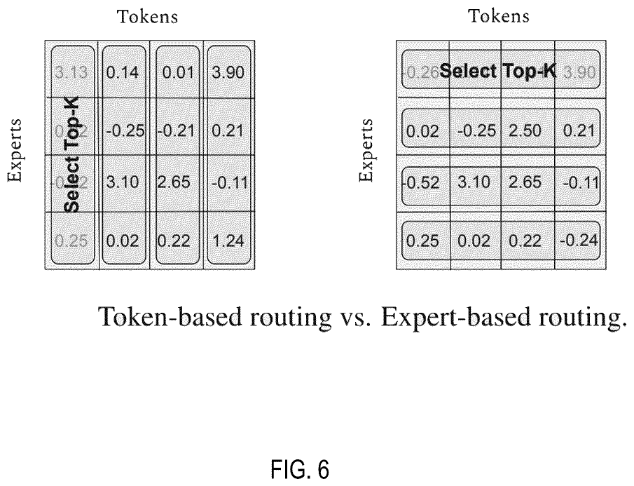

FIG. 6 illustrates example operations of token-based and expert-based routing respectively. In top-k expert-based routing each expert processes k tokens. In top-k token-based routing, is expert processes k tokens.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method, comprising:
receiving training data for a machine learning task that requires processing an input sequence of tokens to generate a network output for the input sequence of tokens;
generating a plurality of candidate neural networks for performing the machine learning task, wherein each candidate neural network comprises a plurality of instances of a layer block, wherein the layer block comprises a sequence of a plurality of layers that each update each token in the input sequence and wherein the generating comprises, for each candidate neural network, selecting a respective type for each of the plurality of layers from a set of layer types that comprises:
(i) A temporal mixture sublayer that captures relationships among the tokens in the input sequence,
(ii) A dense feed-forward sub-layer that operates independently on each token in the input sequence, and
(iii) A conditional computational layer that operates independently on each token in the input sequence and that selects, for each token, one or more of a plurality of neural networks for processing the token;
for each of the candidate neural networks, training the candidate neural network on at least a portion of the training data to generate a trained candidate neural network and determining a performance score for the trained candidate neural network that characterizes the performance of the trained candidate neural network on the machine learning task; and
determining a final neural network for performing the machine learning task based at least on the performance scores for the candidate neural networks.

2. The method of claim 1, wherein generating the plurality of candidate neural networks comprises performing an evolutionary search over a search space over candidate neural networks.

3. The method of claim 2 wherein the evolutionary search is guided by the performance scores for the candidate neural network subject to one or more constraints.

4. The method of claim 1, wherein training the candidate neural network on at least a portion of the training data comprises:
training each candidate neural network on a same set of one or more first target hardware devices for a same amount of wall clock time.

5. The method of claim 1, further comprising:
determining, for each candidate neural network, whether a step time of the candidate neural network satisfies one or more criteria.
wherein determining a final neural network for performing the machine learning task based at least on the performance scores for the candidate neural networks comprises:
selecting, from the candidate neural networks that have step times that satisfy the one or more criteria, the candidate neural network having a best performance on the machine learning task.

6. The method of claim 5, wherein the step time of the candidate neural network measures a time required for the candidate neural network to generate a respective network output for each input sequence in a set of one or more input sequences when deployed on a set one or more second target hardware devices.

7. The method of claim 5 wherein the one or more criteria include a first criterion requiring that the step time of the candidate neural network be less than a baseline step time of a baseline neural network for the machine learning task by at least a threshold amount of time.

8. The method of claim 7, wherein the threshold amount of time is zero.

9. The method of claim 1, wherein determining a performance score for the trained candidate neural network comprises:
determining a validation accuracy of the trained candidate neural network on a set of validation data for the machine learning task.

10. The method of claim 1, wherein the generating comprises, for each candidate neural network, selecting, for each of the plurality of layers one or more respective dimension values that specify a dimensionality of the tokens when processed by each of the components of the layer.

11. The method of claim 10, wherein different layer types in the set of layer types have different sets of possible values.

12. The method of claim 1, wherein the generating comprises, for each candidate neural network, selecting, for each of the plurality of layers for which the selected layer type is the conditional computation sub-layer, a respective routing scheme for routing tokens to expert neural networks from a set of possible routing schemes.

13. The method of claim 12, wherein the set of possible routing schemes comprises token-based routing and expert-based routing.

14. The method of claim 1, wherein each expert neural network is deployed on a respective device from a plurality of devices, and wherein the generating comprises, for each candidate neural network, selecting, for each of the plurality of layers for which the selected layer type is the conditional computation sub-layer, a capacity factor from a set of possible capacity factors that each specify a different maximum number of tokens from the input sequence that can be routed to any one of the plurality of devices.

15. The method of claim 1, wherein the generating comprises, for each candidate neural network, selecting, for each of the plurality of layers, a respective activation function to be applied within the layer from a set of possible activation functions.

16. The method of claim 1, further comprising:
providing data specifying the final neural network for use in performing the machine learning task.

17. The method of claim 1, further comprising:
receiving a new input sequence; and
performing the machine learning task on the new input sequence by processing the new input sequence using the final neural network.

18. The method of claim 1, wherein the temporal mixture sub-layer is a self-attention sub-layer that applies self-attention over the tokens.

19. The method of claim 18, wherein the self-attention is causal self-attention.

20. The method of claim 18, wherein the generating comprises, for each candidate neural network, selecting, for each of the plurality of layers for which the selected layer type is the temporal mixture sub-layer, a number of attention heads to be included in the temporal mixture sub-layer from a set of possible numbers.

21. A method comprising:
receiving an input sequence of tokens; and
processing the input sequence of tokens using a neural network to generate a network output for the input sequence of tokens, wherein the neural network comprises a plurality of instances of a layer block, wherein the layer block comprises a sequence of a plurality of layers that each update each token in the input sequence, and wherein the plurality of layers comprises:
at least one temporal mixture sub-layer that captures relationships among the tokens in the input sequence,
(ii) at least one dense feed-forward sub-layer that operates independently on each token in the input sequence, and
(iii) at least one conditional computational layer that operates independently on each token in the input sequence and that selects, for each token, one or more of a plurality of expert neural networks for processing the token.
